(19) United States
(12) Patent Application Publication
(10) Pub. No.: US 2013/0113314 A1
(43) Pub. Date: May 9, 2013

(54) SPINDLE MOTOR AND METHOD OF MANUFACTURING THE SAME

(71) Applicant: Samsung Electro-Mechanics co., Ltd., Suwon (KR)

(72) Inventor: Tae Hyeong LIM, Suwon (KR)

(73) Assignee: SAMSUNG ELECTRO-MOCHANICS CO., LTD., Suwon (KR)

(21) Appl. No.: 13/653,971

(22) Filed: Oct. 17, 2012

(30) Foreign Application Priority Data
Nov. 7, 2011 (KR) 10-2011-0114897

(51) Int. Cl. H02K 11/00; H02K 15/00

(52) U.S. Cl. 310/71; 29/596

(57) ABSTRACT

There is provided a spindle motor including: a base member having a through-hole formed therein; a circuit board installed on a lower surface of the base member and including a communication hole formed therein to correspond to the through-hole; an insulating member insertedly disposed in the through-hole and having a lead part of a coil penetrating therethrough; and a sealing member filling a space formed by the insulating member insertedly disposed in the through-hole and the base member to thereby close the through-hole.

### CROSS-REFERENCE TO RELATED APPLICATIONS

This application claims the priority of Korean Patent Application No. 10-2011-0114897 filed on Nov. 7, 2011, in the Korean Intellectual Property Office, the disclosure of which is incorporated herein by reference.

### BACKGROUND OF THE INVENTION

1. Field of the Invention

The present invention relates to a spindle motor and a method of manufacturing the same.

2. Description of the Related Art

A hard disk drive (HDD), an information storage device, writes data to a disk or reproduces data stored on a disk using a read/write head (hereinafter, referred to as a head).

In hard disk drives, a head performs its function while being moved to a desired position by an actuator in a state in which it is suspended above a writing surface of a rotating disk at a predetermined height.

Recently, as a portable electronic devices such as portable multimedia players (PMPs), personal digital assistants (PDAs), camcorders, MP3 players, laptop computers, navigation devices, and the like have gradually become multi-functionalized, a hard disk drive capable of storing a large amount of information thereon has been adopted.

In accordance with the trend toward slimness and lightness in portable electronic devices for improving the portability thereof, a small-sized hard disk drive using a disk having a significantly small diameter has been adopted.

In addition, the above-mentioned hard disk drive includes a disk, a motor for rotating the disk, a head, and an actuator, which are received in and protected by a housing including a base and a cover.

Meanwhile, the motor rotating the disk, a device converting electrical energy into mechanical energy using force applied to a conductor in which current flows within a magnetic field, basically generates driving force rotating the disk by electromagnetic interaction between a magnet and a coil.

Further, in order to generate the driving force for rotating the disk, the coil needs to be electrically connected to an external power source, such that current maybe supplied from the outside thereto. To this end, one end portion of the coil needs to be led out from an internal space of the housing including the base and the cover to the outside through the base, to thereby be bonded to and installed on a circuit board.

In addition, after one end portion of the coil is led out, a lead hole through which one end portion of the coil is led needs to be closed in order to prevent electrical leakage from being generated.

However, at the time of attachment and installation of the circuit board, electrical leakage may be generated according to a shape of a lower surface of the base or an installation state of the circuit board. Further, a risk of electrical leakage generation increases in the case in which adhesion of the circuit board is weak or in the case in which a cold solder joint, or the like, is generated at the time of soldering of one end portion of the coil.

In addition, in order to prevent electrical leakage, a method of coating the entire region of a lower surface of the circuit board has been used. However, in the case of this method, workability and manufacturing costs may increase.

Further, even in the case in which the entire region of the lower surface of the circuit board is coated, the risk of electrical leakage may not be removed according to a bonding state of the circuit board.

### SUMMARY OF THE INVENTION

An aspect of the present invention provides a spindle motor capable of having improved insulation characteristics, and a method of manufacturing the same.

Another aspect of the present invention provides a spindle motor capable of being manufactured at reduced cost, and a method of manufacturing the same.

According to an aspect of the present invention, there is provided a spindle motor including: a base member having a through-hole formed therein; a circuit board installed on a lower surface of the base member and including a communication hole formed therein to correspond to the through-hole; an insulating member insertedly disposed in the through-hole and having a lead part of a coil penetrating therethrough; and a sealing member filling a space formed by the insulating member insertedly disposed in the through-hole and the base member to thereby close the through-hole.

The insulating member may be provided with an installation hole through which the lead part of the coil penetrates, the installation hole being tapered.

The installation hole of the insulating member may have a wider diameter in an upper portion thereof as compared to a lower portion thereof, so that the lead part of the coil may easily penetrate therethrough.

The sealing member may be formed of an ultraviolet (UV) bonding material to be easily introduced into the space formed by the insulating member and the base member at the time of application thereof.

The circuit board may include a bonding part disposed in the vicinity of the communication hole and having the lead part of the coil bonded thereto.

The insulating member may be installed on the base member such that a lower surface thereof maybe disposed within the through-hole.

The communication hole may have a diameter smaller than that of the through-hole in order to suppress separation of the sealing member filling the space formed by the insulating member and the base member.

According to another aspect of the present invention, there is provided a method of manufacturing a spindle motor, the method including: insertedly mounting an insulating member in a through-hole of a base member; mounting a circuit board on a lower surface of the base member such that a communication hole of the circuit board is in communication with the through-hole; leading a lead part of a coil to penetrate through the insulating member to thereby bond the lead part of the coil to a bonding part of the circuit board; and applying a sealing member to fill a space formed by the insulating member and the base member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is an exploded perspective view showing a base member and a circuit board of a spindle motor according to an embodiment of the present invention; and

FIGS. 4 through 7B are views describing a method of manufacturing a spindle motor according to an embodiment of the present invention.

### DETAILED DESCRIPTION OF THE INVENTION

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Moreover, detailed descriptions related to well-known functions or configurations will be ruled out in order not to unnecessarily obscure subject matters of the present invention.

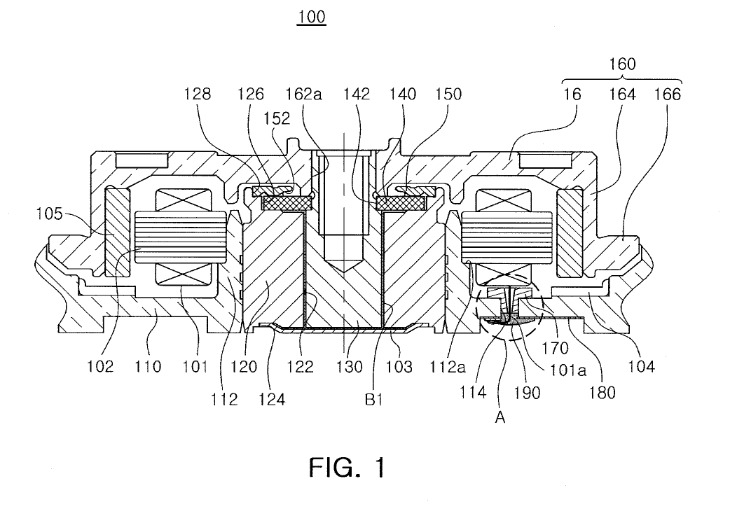

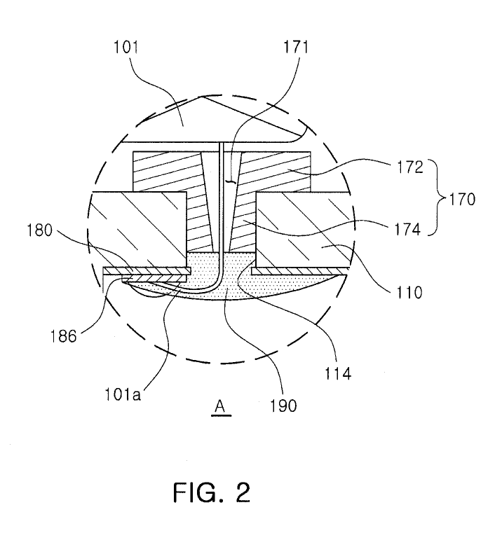

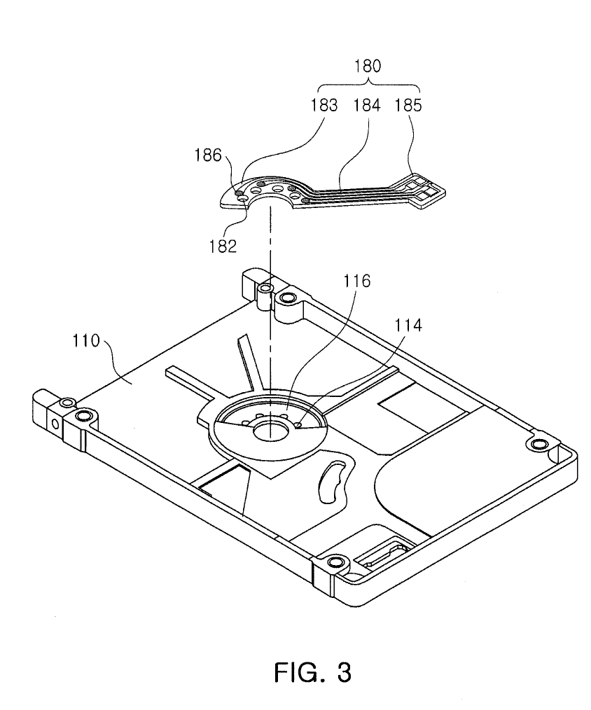

FIG. 1 is a schematic cross-sectional view showing a spindle motor according to an embodiment of the present invention; FIG. 2 is an enlarged view of part A of FIG. 1; and FIG. 3 is an exploded perspective view showing a base member and a circuit board of the spindle motor according to the embodiment of the present invention.

Referring to FIGS. 1 through 3, a spindle motor 100 according to an embodiment of the present invention may include, for example, a base member 110, a sleeve 120, a shaft 130, a thrust plate 140, a cap member 150, a rotor hub 160, an insulating member 170, a circuit board 180, and a sealing member 190.

Meanwhile, the spindle motor 100 may be a motor used in a recording disk driving device driving a recoding disk.

Here, terms with respect to directions will be first defined. As viewed in FIG. 1, an axial direction refers to a vertical direction, that is, a direction from an upper portion of the shaft 130 toward a lower portion thereof or a direction from the lower portion of the shaft 130 toward the upper portion thereof, and a radial direction refers to a horizontal direction, that is, a direction from an outer peripheral surface of the rotor hub 160 toward the shaft 130 or from the shaft 130 toward the outer peripheral surface of the rotor hub 160.

In addition, a circumferential direction refers to a rotation direction along the outer peripheral surface of the rotor hub 160.

The base member 110 may include a protrusion part 112 having the sleeve 120 installed therein. The protrusion part 112 may protrude upwardly in the axial direction, and the sleeve 120 may be insertedly installed in the protrusion part 112.

In addition, the protrusion part 112 may include a stator core 102 installed on an outer peripheral surface thereof, and the stator core 102 has a coil 101 wound therearound. That is, the stator core 102 may be fixedly installed by using an adhesive and/or welding in a state in which it is seated on a seating surface 112a formed on the outer peripheral surface of the protrusion part 112.

Meanwhile, the base member 110 may include a through-hole 114 formed therein to be disposed in the vicinity of the protrusion part 112. In addition, a lead part 101a of a coil 101 wound around the stator core 102 may be led from an upper portion of the base member 110 to a lower portion thereof through the through-hole 114.

In addition, the base member 110 may include a pulling plate 104 installed thereon in order to prevent the rotor hub 160 from being excessively floated, and the pulling plate 104 may have an annular ring shape.

The sleeve 120 may be fixedly installed to the protrusion part 112 as described above. That is, an outer peripheral surface of the sleeve 120 may be adhered to an inner peripheral surface of the protrusion part 112 by an adhesive or the sleeve 120 may be press-fitted into the protrusion part 112.

Further, the sleeve 120 may include a shaft hole 122 formed therein so that the shaft 130 may be insertedly installed therein. That is, the sleeve 120 may have a hollow cylindrical shape.

Meanwhile, in the case in which the shaft 130 is mounted into the sleeve 120, an inner peripheral surface of the sleeve 120 and the outer peripheral surface of the shaft 130 may be spaced apart from each other by a predetermined interval to thereby form a bearing clearance E1 therebetween. In addition, this bearing clearance B1 may be filled with a lubricating fluid.

In addition, the sleeve 120 may include a dynamic pressure generating groove (not shown) formed in the inner surface thereof, the dynamic pressure generating groove generating fluid dynamic pressure by pumping the lubricating fluid filling the bearing clearance B1 at the time of rotation of the shaft 130.

In addition, the sleeve 120 may include a cover member 103 installed on a lower end portion thereof in order to prevent the lubricating fluid filling the bearing clearance B1 from being leaked downwardly. That is, the sleeve 120 may include a recess 124 recessed upwardly into the lower end portion thereof such that the cover member 103 may be inserted into the lower end portion thereof.

Meanwhile, an insertion groove 126 may be formed in an upper end portion of the sleeve 120, and may have the thrust plate 140 inserted thereinto. A bonding groove part 128 maybe formed outwardly of the insertion groove 126 such that the cap member 150 is fixedly installed thereto.

The shaft 130 maybe rotatably installed in the sleeve 120. That is, as described above, the shaft 130 may be insertedly disposed in the shaft hole 122 of the sleeve 120.

Further, the thrust plate 140 and the rotor hub 160 may be sequentially installed on an upper end portion of the shaft 130. That is, when the thrust plate 140 and the rotor hub 160 may be installed onto the shaft 130, the rotor hub 160 may be disposed on an upper portion of the thrust plate 140.

The thrust plate 140 may fixed to the shaft 130 to be disposed on the upper portion of the sleeve 120. That is, in the case in which the shaft 130 is installed in the sleeve 120, the thrust plate 140 may be inserted into the insertion groove 126 formed on the upper end portion of the sleeve 120. To this end, the thrust plate 140 maybe fixed to the upper end portion of the shaft 130.

Meanwhile, a thrust dynamic pressure generating groove (not shown) for generating fluid dynamic pressure at the time of rotation of the thrust plate 140 may be formed in at least one of a lower surface of the thrust plate 140 and a bottom surface of the insertion groove 126.

In addition, the thrust plate 140 may have a circular ring shape in which it has an installation hole 142 formed therein such that the shaft 130 may penetrate therethrough.

The cap member 150 may be fixed to the sleeve 120 and have an inclined surface 152 to form a liquid-vapor interface (that is, an interface between the lubricating fluid and air) together with the thrust plate 140.

Meanwhile, the inclined surface 152 may be formed on a lower surface of the cap member 150, and the interface between the lubricating fluid and the air, that is, the liquid-vapor interface may be disposed in a space between the inclined surface 152 and the upper surface of the thrust plate 140.

The rotor hub 160 may include a body 162 having a disk shape, a magnet coupling part 164 extended downwardly an edge of the body 162 in the axial direction, and a disk seating part 166 extended from the magnet coupling part 164 in the radial direction and having a disk seated thereon.

The body 162 may include amounting hole 162a for being fixedly mounted to the shaft 130, and the mounting hole 162a may be formed in a central portion of the body 162.

Meanwhile, the magnet mounting part 164 may have a driving magnet 105 installed on an inner surface thereof, and the driving magnet 105 is disposed to face the stator core 102 having the coil 101 wound around. In addition, the driving magnet 105 may have an annular ring shape and be a permanent magnet generating magnetic force having a predetermined strength by alternately magnetizing N and S poles in the circumferential direction.

Here, the rotational driving of the rotor hub 160 will be described. When power is supplied to the coil 101 wound around the stator core 102, driving force capable of rotating the rotor hub 160 may be generated by electromagnetic interaction between the driving magnet 105 and the stator core 102 having the coil 101 wound therearound.

Therefore, the rotor hub 160 rotates, such that the shaft 130 to which the rotor hub 160 is fixedly coupled may rotate together with the rotor hub 160.

The insulating member 170 may be insertedly disposed in the through-hole 114. In addition, the lead part 101a of the coil 101 may be installed in the insulating member 170 to penetrate therethrough. That is, the insulating member 170 is installed to be inserted from an upper portion of the base member 110 into the through-hole 114.

In addition, the insulating member 170 may be provided with an installation hole 171 through which the lead part 101a of the coil 101 penetrates, and the installation hole 171 may be tapered.

The insulating member 170 will be described in more detail. The insulating member 170 may include a disk part 172 having a disk shape and an insertion part 174 extended downwardly from the disk part 172 in the axial direction.

In addition, the installation hole 171 may penetrate through the disk part 172 and the insertion part 174. In addition, the installation hole 171 may have a wider diameter in an upper portion thereof as compared to a lower portion thereof so that the lead part 101a of the coil 101 may be easily led therein and penetrate therethrough.

Meanwhile, the insulating member 170 may have a lower surface disposed within the through-hole 114 when being installed on the base member 110. That is, the insertion part 174 may have a length smaller than a thickness of the base member 110.

Therefore, the insulating member 170 and the base member 110 may form a predetermined space. That is, since the length of the insertion part 174 is smaller than the thickness of the base member 110, a predetermined space may be formed by the lower surface of the insulating member 170 and the through-hole 114 of the base member 110.

The circuit board 180 may be installed on the lower surface of the base member 110 and include a communication hole 182 corresponding to the through-hole 114. That is, in the case in which the circuit board 180 is installed on the base member 110, the communication hole 182 of the circuit board 180 may be disposed under the through-hole 114.

In addition, the circuit board 180 may include a ring part 183 inserted into a mounting groove 116 formed in the lower surface of the base member 110, an extension part 184 extended from the ring part 183, and a connection terminal part 185 connected to a distal end of the extension part 184, as shown in FIG. 3.

In addition, a plurality of communication holes 182 may be disposed in the ring part 183 to be spaced apart from each other. Further, the communication hole 182 may have a diameter smaller than that of the through-hole 114 so at to suppress separation of the sealing member 190 filling the space formed by the insulating member 170 and the base member 110.

Meanwhile, the circuit board 180 may include a bonding part 186 disposed in the vicinity of the communication hole 182 and to which the lead part 101a of the coil 101 is bonded.

In addition, the circuit board 180 may be a flexible circuit board formed of a soft material.

Further, the circuit board 180 may include wiring patterns formed thereon in order to electrically connect the bonding part 186 and the connection terminal part 185 to each other.

The sealing member 190 may fill the space formed by the insulating member 170 insertedly disposed in the through-hole 114 and the base member 110 to thereby close the through-hole 114. To this end, the sealing member 190 may be formed of, for example, an ultraviolet (UV) bonding material.

That is, after the lead part 101a of the coil 101 is bonded to the bonding part 186 of the circuit board 180 by welding, the sealing part 190 may be injected into the through-hole 114.

As such, the sealing member 190 is injected into the through-hole 114, whereby electric leakage through the through-hole 114 may be suppressed.

That is, the sealing member 190 is applied to fill the space formed by the lower surface of the insulating member 170 and the base member 110, whereby the electric leakage through the through-hole 114 may be suppressed.

More specifically, according to the related art, the sealing member 190 is applied to the lower surface of the circuit board 180, more particularly, the entirety of the lower surface of the ring part 183 to thereby close the through-hole 114.

Therefore, electric leakage is generated according to an installation state of the circuit board 180 (the case in which the circuit board is bonded to the base member in a state of being floated) and adhesive strength.

However, as described above, the sealing member 190 is injected into the through-hole 114 and the through-hole 114 is closed regardless of the installation state of the circuit board 180 and the adhesive strength, whereby the occurrence of electric leakage may be prevented.

In addition, since an application amount of the sealing member 190 may be significantly reduced, manufacturing costs may be reduced. In other words, the sealing member 190 is applied to the inside of the through-hole 114 and directly under the through-hole 114, whereby the application amount of the sealing member 190 may be reduced.

Hereinafter, a method of manufacturing a spindle motor according to an embodiment of the present invention will be described with reference to the accompanying drawings. However, the same reference numerals will be used to describe the same components as the above-mentioned components.

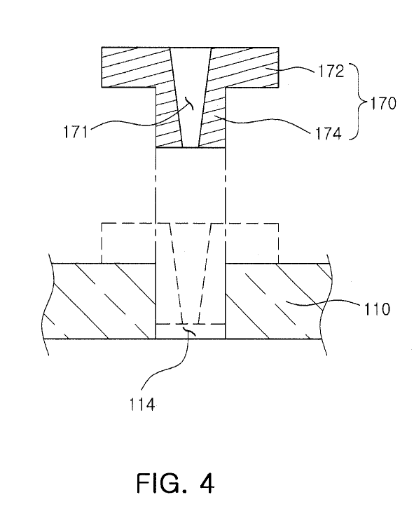

FIGS. 4 through 7B are views showing a method of manufacturing a spindle motor according to an embodiment of the present invention.

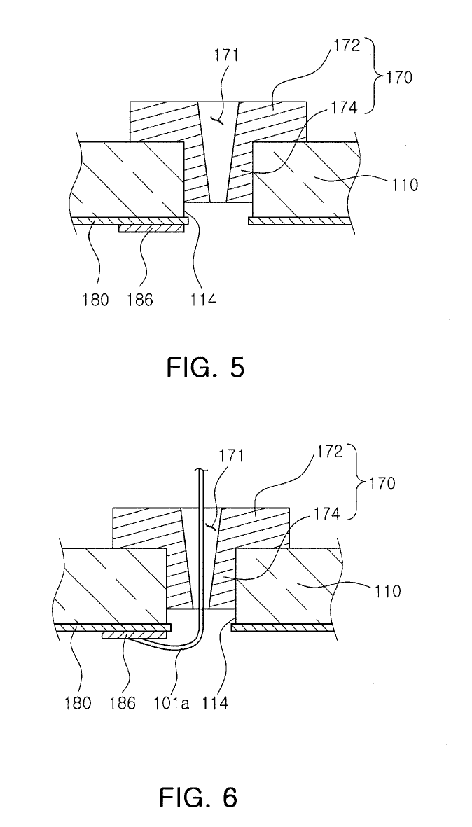

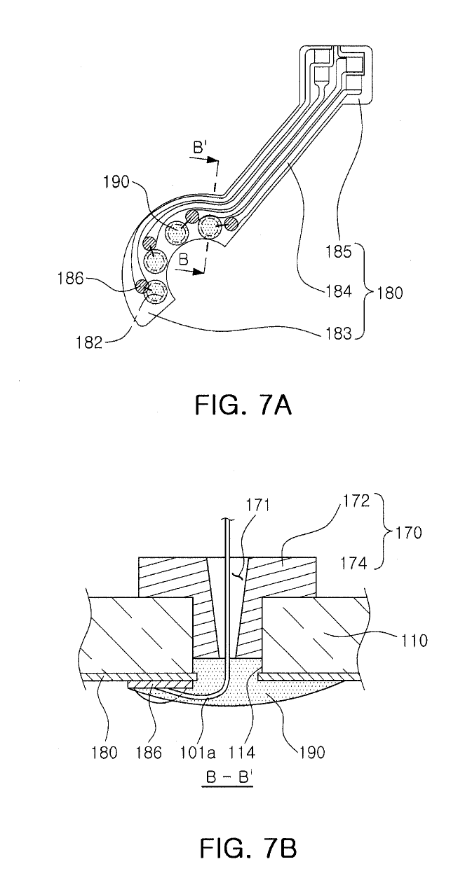

FIG. 4 is a view describing a process of installing the insulating member 170 on the base member 110; FIG. 5 is a view describing a process of installing the circuit board 180 on the base member 110; FIG. 6 is a view describing a process of leading the lead part 101a of the coil 101 from the upper portion of the base member 110 to the lower portion thereof to thereby bond the lead part 101a of the coil 101 to the circuit board 180; and FIGS. 7A and 7B are views describing a process of applying the sealing member 190.

First, referring to FIG. 4, the insulating member 170 may be installed on the base member 110. Here, the insulating member 170 may be disposed on the upper surface of the base member 110. That is, the insulating member 170 may be installed by causing a lower surface of the ring part 172 to contact the upper surface of the base member 110 and inserting the insertion part 174 into the through-hole 114.

In addition, since the length of the insertion part 174 is smaller than the thickness of the base member 110, the distal end of the insertion part 174 may be insertedly disposed in the through-hole 114. Therefore, a predetermined space may be formed by the base member 110 and the insulating member 170.

Then, as shown in FIG. 5, the circuit board 180 may be installed on the lower surface of the base member 110. Here, the communication hole 182 of the circuit board 180 may be disposed to face the through-hole 114.

Meanwhile, the communication hole 182 may have a diameter smaller than that of the through-hole 114 to thereby close an edge of the through-hole 114. Although the embodiment of the present invention describes a case in which the communication hole 182 and the through-hole 114 have different diameters by way of example, the present invention is not limited thereto. That is, the through-hole 114 and the communication hole 182 may have the same diameter.

Thereafter, as shown in FIG. 6, the lead part 101a of the coil 101 may be led from the upper portion of the base member 110 to the lower portion thereof to thereby be bonded to the bonding part 186 of the circuit board 180.

Here, the installation hole 171 may have a wider diameter in the upper portion thereof as compared to the lower portion thereof , such that the lead part 101a may be more easily led.

Next, as shown in FIGS. 7A and 7B, the sealing member 190 may be injected into the through-hole 114. Here, the sealing member 190 is not applied to the entirety of the ring part 182 of the circuit board 180 but may be applied directly under the through-hole 114 to be injected into the through-hole 114.

As described above, the sealing member 190 is applied to be injected into the through-hole 114 to close the through-hole 114 regardless of the installation state of the circuit board 180 and the adhesive strength, whereby the occurrence of electric leakage may be prevented.

In addition, since an application amount of the sealing member 190 may be significantly reduced, manufacturing costs may be reduced. In other words, the sealing member 190 is applied into the through-hole 114 and directly under the through-hole 114, whereby the application amount of the sealing member 190 may be reduced.

As set forth above, the sealing member fills the space formed by the base member and the insulating member, whereby insulating characteristics may be improved and the application amount of the sealing member may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a base member having a through-hole formed therein;
a circuit board installed on a lower surface of the base member and including a communication hole formed therein to correspond to the through-hole;
an insulating member insertedly disposed in the through-hole and having a lead part of a coil penetrating therethrough; and
a sealing member filling a space formed by the insulating member insertedly disposed in the through-hole and the base member to thereby close the through-hole.

2. The spindle motor of claim 1, wherein the insulating member is provided with an installation hole through which the lead part of the coil penetrates, the installation hole being tapered.

3. The spindle motor of claim 2, wherein the installation hole of the insulating member has a wider diameter in an upper portion thereof as compared to a lower portion thereof so that the lead part of the coil easily penetrates therethrough.

4. The spindle motor of claim 1, wherein the sealing member is formed of an ultraviolet (UV) bonding material to be easily introduced into the space formed by the insulating member and the base member at the time of application thereof.

5. The spindle motor of claim 1, wherein the circuit board includes a bonding part disposed in the vicinity of the communication hole and having the lead part of the coil bonded thereto.

6. The spindle motor of claim 1, wherein the insulating member is installed on the base member such that a lower surface thereof is disposed within the through-hole.

7. The spindle motor of claim 1, wherein the communication hole has a diameter smaller than that of the through-hole in order to suppress separation of the sealing member filling the space formed by the insulating member and the base member.

8. A method of manufacturing a spindle motor, the method comprising:
insertedly mounting an insulating member in a through-hole of a base member;
mounting a circuit board on a lower surface of the base member such that a communication hole of the circuit board is in communication with the through-hole;
leading a lead part of a coil to penetrate through the insulating member to thereby bond the lead part of the coil to a bonding part of the circuit board; and
applying a sealing member to fill a space formed by the insulating member and the base member.

9. The method of claim 8, wherein the insulating member is installed on the base member such that a lower surface thereof is disposed within the through-hole.

10. The method of claim 8, wherein the insulating member is provided with an installation hole through which the lead part of the coil penetrates, the installation hole being tapered to have a wider diameter in an upper portion thereof as compared to a lower portion thereof so that the lead part of the coil easily penetrates therethrough.
